(19) United States
(12) Patent Application Publication
(10) Pub. No.: US 2020/0045414 A1
(43) Pub. Date: Feb. 6, 2020

(54) SPEAKER BOX

(71) Applicant: AAC Technologies Pte. Ltd., Singapore city (SG)

(72) Inventors: Jun Wu, Shenzhen (CN); Kaihua Shen, Shenzhen (CN); Yue Ren, Shenzhen (CN)

(21) Appl. No.: 16/528,626

(22) Filed: Aug. 1, 2019

(30) Foreign Application Priority Data
Aug. 2, 2018 (CN) 201810873710.3

(51) Int. Cl. H04R 1/28; H04R 1/02

(52) U.S. Cl. CPC H04R 1/2811; H04R 1/021

(57) ABSTRACT

The present disclosure provides a speaker box which comprises a shell having a receiving space, a speaker accommodated in the receiving space, a support wall extending from an inner side of the shell, and a sound guiding channel formed in the receiving space. The speaker is fixedly supported on the support wall. The speaker comprises a diaphragm for vibration and producing sound via irradiation, and the diaphragm partitions the receiving space into a front sound cavity and a rear cavity. The sound guiding channel communicates the front sound cavity with the outside and forms the front cavity with the front sound cavity. The speaker box also includes a surrounding wall formed by extending the inner side of the shell and a cover plate which is arranged on the surrounding wall.

### FIELD OF THE DISCLOSURE

The present disclosure relates to acoustic-electro transducers, and more particularly to a speaker box used in a portable electronic device.

### DESCRIPTION OF RELATED ART

With the advent of the mobile Internet era, a drastically increasing number of smart mobile devices are being used. In all these mobile devices, mobile phones are most common and most portable mobile terminal devices. At present, mobile phones are powerfully in functionality. One of the powerful functions is the high-quality music function. Therefore, speaker boxes for playing music are widely applied to the conventional smart mobile devices.

A speaker box in the related art includes a housing having a receiving space, a speaker received in the housing and a sound guiding channel received in the receiving space. The speaker includes a diaphragm for vibration to produce sound via irradiation. The diaphragm partitions the receiving space into a front sound cavity and a rear cavity. The sound guiding channel communicates the front sound cavity with the outside, and cooperatively defines a front cavity with the front sound cavity.

However, in the speaker box in the related art, the front cavity has a space which is limited to a region rightly opposite to a dome and a region of the sound guiding channel, and the structure is monotonous and may not be optimized. Therefore, high-frequency acoustic performance of the speaker box is subject to restrictions, and over-high high-frequency responses may cause harsh sounds, sharp dentilabial sounds and the like poor sound effects.

Therefore, it is desired to provide a speaker box to overcome the aforesaid problems.

### BRIEF DESCRIPTION OF THE DRAWINGS

Many aspects of the exemplary embodiments can be better understood with reference to the following drawings. The components in the drawing are not necessarily drawn to scale, the emphasis instead being placed upon clearly illustrating the principles of the present disclosure. Moreover, in the drawings, like reference numerals designate corresponding parts throughout the several views.

FIG. 1 is a schematic diagram of a three-dimensional structure of the speaker box in accordance with an exemplary embodiment of the present disclosure;

FIG. 2 is a schematic diagram of the part of three-dimensional structure of the speaker box exploded view showing in FIG. 1;

FIG. 3 is a cross-sectional view along the A-A line showing in FIG. 1;

FIG. 4 is a frequency response graph of a speaker box of the related art; and

FIG. 5 is a graph showing the frequency response of different embodiments of the speaker box of the present disclosure by adjusting the number and the location of resonant cavities.

### DETAILED DESCRIPTION

The present disclosure will hereinafter be described in detail with reference to several exemplary embodiments. To make the technical problems to be solved, technical solutions and beneficial effects of the present disclosure more apparent, the present disclosure is described in further detail together with the figure and the embodiments. It should be understood the specific embodiments described hereby is only to explain the disclosure, not intended to limit the disclosure.

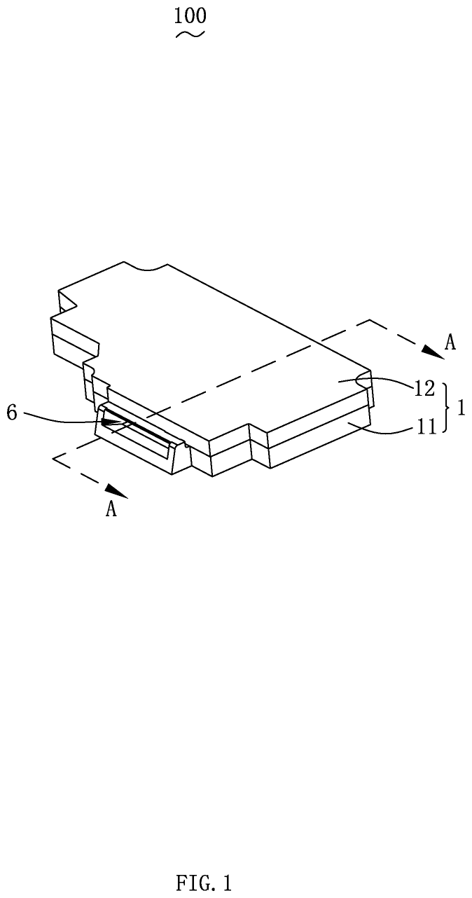

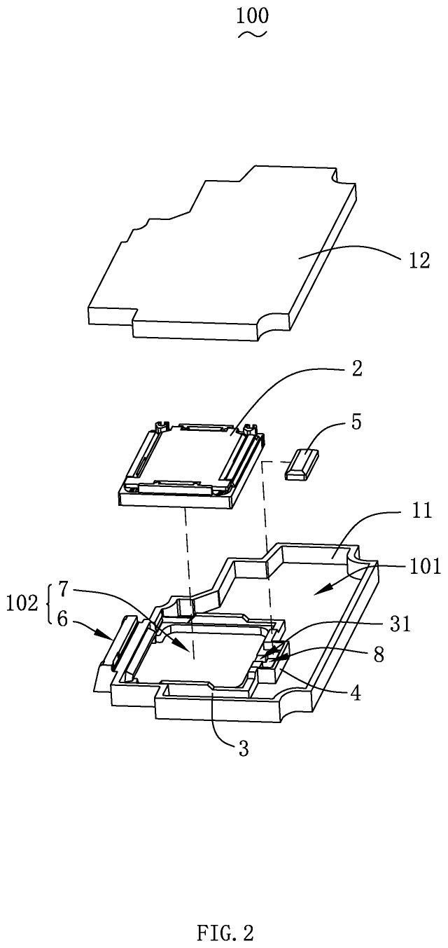

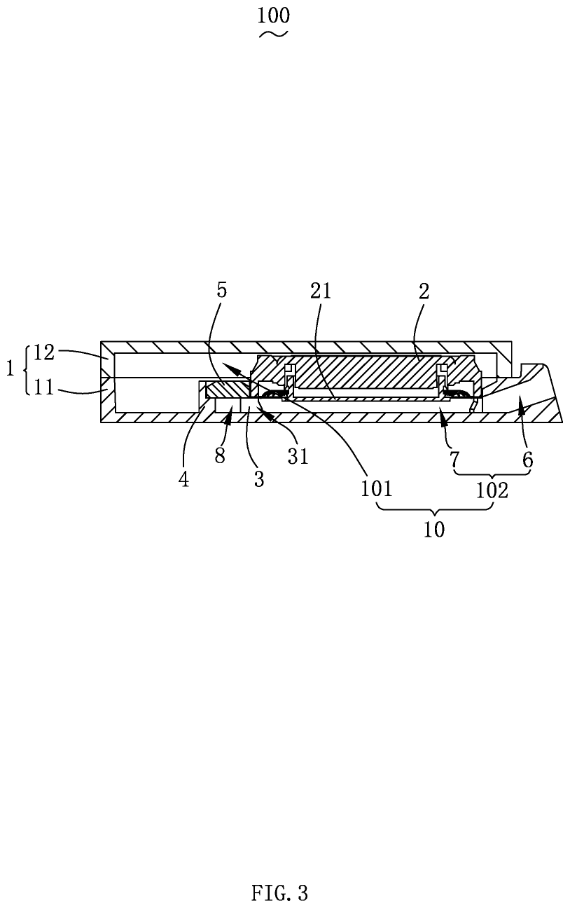

Please also refer to FIG. 1 to FIG. 3, wherein FIG. 1 is a schematic diagram of a three-dimensional structure of the speaker box in accordance with an exemplary embodiment of the present disclosure, FIG. 2 is a schematic diagram of the part of three-dimensional structure of the speaker box exploded view showing in FIG. 1, FIG. 3 is a cross-sectional view along the A-A line showing in FIG. 1.

The present disclosure provides a speaker box 100, which comprises a shell 1 having a receiving space 10 and a speaker 2 housing in the receiving space 10.

The shell 1 comprises a support wall 3, a surrounding wall 4, a cover plate 5, and a sound guiding channel 6. The support wall 3 and the surrounding wall 4 are disposed in the inner of the shell 1 and are formed by extending from the shell 1. The surrounding wall 4 is located on the outside of the support wall 3.

The shell 1 can be either integrated into a whole structure or separated into a split structure. For example, in this embodiment, the shell 1 comprises an upper cover 11, and a lower cover 12 covering with the upper cover 11 and cooperatively defining the receiving space 10 with the upper cover 11.

The speaker 2 is accommodated in the receiving space 10 of the Shell 1, and the speaker 2 partitions the receiving space 10 into a front sound cavity 7 and a rear cavity 101.

In this embodiment, the speaker 2 is fixedly supported by the support wall 3. The speaker 2 and the upper cover 11 are spaced apart from each other to cooperatively define the front sound cavity 7. The speaker 2 comprises a diaphragm 21 for vibration and producing sound via irradiation, and the diaphragm 21 partitions the receiving space 10 into the front sound cavity 7 and the rear cavity 101. In particular, the diaphragm 21 is spaced apart with the upper cover 11, and cooperates with the upper cover 11 to form the front sound cavity 7. The diaphragm 21, the lower cover 12 and the upper cover 11 cooperatively define the rear cavity 101 together. The rear cavity 101 is used to improve the low-frequency acoustic performance of the speaker box 100.

The sound guiding channel 6 is formed in the receiving space 10. In this embodiment, the sound guiding channel 6 is formed in the upper cover 11. The sound guiding channel 6 communicates the front sound cavity 7 with the outside, and the sound guiding channel 6 is cooperates together with the front sound cavity 7 to form the front cavity 102. The sound guiding channel 6 is used to form a side acoustic structure of the front cavity 102.

The support wall 3 and the surrounding wall 4 are formed in the shell 1. For example, the support wall 3 and the surrounding wall 4 are disposed on the upper cover 11.

Specifically, the cover plate 5 is completely covered on the surrounding wall 4, and the shell 1, the support wall 3, the surrounding wall 4 and the cover plate 5 cooperatively define an auxiliary acoustic cavity 8. The support wall 3 is equipped with a through-hole 31 extending through it, and the auxiliary acoustic cavity 8 is communicated with the front cavity 102 by the through-hole 31 to form the resonant cavity structure of the front cavity 102, which is used to improve the acoustic performance of high frequency acoustics. On the one hand, the structure effectively increases the cavity volume of the front cavity 102, improves the high-frequency acoustic performance, on the other hand, the surrounding wall 4 structure design is more flexible and diverse, less restrictive, and more applicable.

Specifically, the surrounding wall 4 is communicated with the front sound cavity 7 through the through-hole 31. Of course, the auxiliary acoustic cavity 8 can also be communicated with the sound guiding channel 6 through the through-hole 31, which is also possible, and the principle is the same.

Specifically, the speaker 2 is fixed to the support wall 121 by glue bonding, the joint between the cover plate 22 and the surrounding wall 4 is glued to improve the sealing of the front cavity 102 and the auxiliary acoustic cavity 8, so that the high frequency acoustic performance is better.

The cover plate 5 is made of a PET material, which can effectively reduce the resonance peak and distortion of the resonant cavity, thereby making the high-frequency acoustic performance better. Of course, the material of the cover plate is not limited thereto, as long as it can be effective. The principle is the same for a cover plate made of other materials that reduces the resonance peak and distortion of the resonant cavity.

More preferably, one or more of the surrounding wall 4 may be provided, what's more, a plurality of positions of the surrounding wall 4 may be provided too. In the present embodiment, the surrounding wall 4 is provided with one. According to the requirement of acoustic performance adjustment, a plurality of resonant cavities may be formed by increasing the number of surrounding walls and the number of cover plates corresponding to the surrounding wall 4 to increase the volume of the resonant cavity of the front cavity, or by adjusting the position of the surrounding wall to improve high frequency acoustic performance.

In the present embodiment, the through hole 31 has at least one of a rectangular shape, a triangular shape, and a circular shape. Of course, the shape thereof is not limited thereto. The number of the through holes 31 is also not limited and may be one or more.

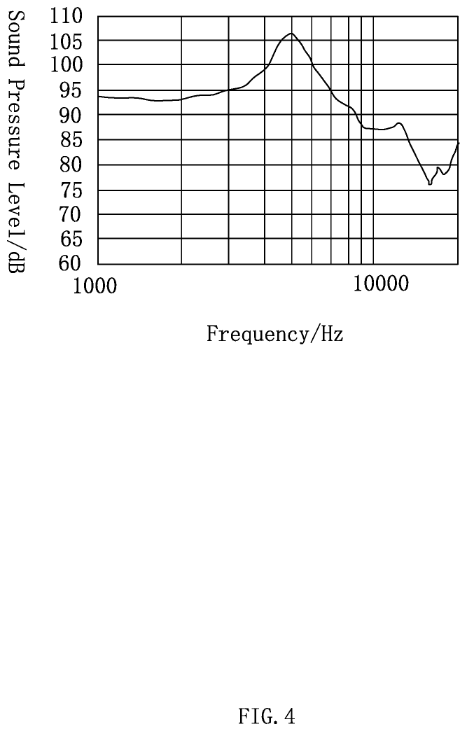

Please refer to FIG. 4, FIG. 4 is a frequency response graph of a speaker box of the related art. When the operating frequency of the speaker box of the related art is at the level of 4000˜6000 Hz, the sound pressure level of the speaker box is greater than 100 dB. When it reaches 5000 Hz, the sound pressure level of the speaker box reaches a peak with a peak value greater than 106 dB. According to the chart analysis, when the working frequency is at the level of 4000˜6000 Hz, the sound pressure level of the speaker box is high, and the actual listening high frequency is harsh, especially the lip tooth sound is sharp, and the high frequency acoustic performance is poor.

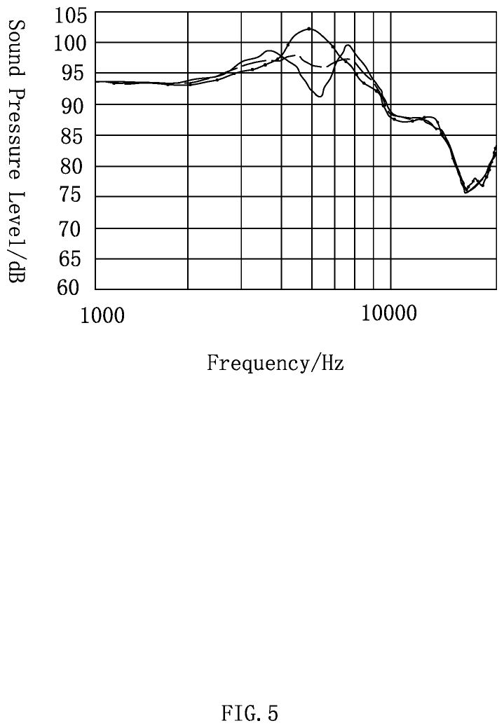

Please refer to FIG. 5, FIG. 5 is a graph showing the frequency response of different embodiments of the speaker box of the present disclosure by adjusting the number and the location of resonant cavities. When the operating frequency is at the level of 4000˜6000 Hz, the sound pressure level corresponding to the frequency response curve of the speaker box of the three different embodiments of the speaker box of the present disclosure is compared with the frequency response curve of the speaker box of the related art shown in FIG. Reduced and peaked. In one embodiment, the speaker box has the highest peak frequency response curve. When the operating frequency is 5000 Hz, the peak corresponding to the sound pressure level is less than 102 dB. In summary, the speaker box of the present disclosure effectively improves high frequency acoustic performance.

Compared with the relevant art, the speaker box 100 of the present disclosure forms an auxiliary acoustic cavity 4 connecting with the front cavity 102 in the shell 11, so that the auxiliary acoustic cavity 4 performs as a part of the front cavity 102 and acts as a resonant cavity, on the one hand, the aforementioned structure effectively increases the volume of the cavity of the front cavity, and improves High-frequency acoustic performance, on the other hand, the auxiliary acoustic cavity structure design is more flexible and diverse, and the applicability is higher. The above structure can effectively reduce the Q value (quality factor value) and sensitivity of the high-frequency resonance peak of the speaker box, so that the acoustic performance of the speaker box better.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A speaker box, comprising:
a shell having a receiving space;
a support wall, which is formed by extending from the inner side of the shell;
a speaker, which is accommodated in the receiving space of the shell and fixed to support the support wall, the speaker comprising:
a diaphragm for vibration and producing sound via irradiation, which partitions the receiving space into a front sound cavity and a rear cavity;
a sound guiding channel, which is formed in the receiving space and communicates the front sound cavity with the outside and cooperates with the front sound cavity to form a front cavity;
a surrounding wall, which is formed by extending from the inner side of the shell and is located outside the supporting wall;
a cover plate, which fully covers the surrounding wall, and the shell, the surrounding wall, the supporting wall and the cover plate cooperatively define an auxiliary acoustic cavity;
wherein the support wall is equipped with a through-hole penetrating therethrough, and the auxiliary acoustic cavity communicates with the front cavity through the through-hole to form a resonant cavity structure of the front cavity.

2. The speaker box as described in claim 1, wherein the auxiliary acoustic cavity is communicated with the front sound cavity through the through-hole.

3. The speaker box as described in claim 1, wherein the shell comprises an upper cover and a lower cover forming a receiving space with the upper cover, the support wall and the surrounding wall are formed on the upper cover, and the speaker is fixedly supported on the support wall and cooperatively defines the front sound cavity with the upper cover.

4. The speaker box as described in claim 1, wherein the speaker is fixed to the support wall by glue bonding, and the joint between the cover plate and the surrounding wall is glued bonding.

5. The speaker box as described in claim 4, wherein the cross-section of the through-hole is one of the rectangles, triangles and circles.

6. The speaker box as described in claim 1, wherein the cover plate is made of PET material.
